(19) United States
(12) Patent Application Publication
(10) Pub. No.: US 2018/0082381 A1
(43) Pub. Date: Mar. 22, 2018

(54) SYSTEMS AND METHODS FOR DYNAMICALLY PROVIDING FINANCIAL LOAN PRODUCTS

(71) Applicant: Capital One Financial Corporation, McLean, VA (US)

(72) Inventors: HANNES JOUHIKAINEN, Arlington, VA (US); Luke A. Hammock, Washington, DC (US); Janusz Michael Niczyporuk, Vienna, VA (US)

(73) Assignee: Capital One Financial Corporation, McLean, VA (US)

(21) Appl. No.: 15/824,911

(22) Filed: Nov. 28, 2017

Related U.S. Application Data
(63) Continuation of application No. 14/202,095, filed on Mar. 10, 2014.
(60) Provisional application No. 61/776,250, filed on Mar. 11, 2013.

(51) Int. Cl. G06Q 40/08

(52) U.S. Cl. CPC G06Q 40/08

(57) ABSTRACT

The disclosed embodiments include methods and systems for collecting, managing, and processing business data for lending services. In one embodiment, a lending system is disclosed that may register a small business with a lending service provided by a lending system and receive first small business data from the small business. The lending system may store the first small business data and analyze the first small business data to determine whether the small business qualifies for a loan product provided by a financial service provider. In another embodiment, the lending system may determine, based on the analysis, that additional business data is needed to determine whether the small business qualifies for the loan product. The lending system may further receive second small business data from the small business and analyze the second small business data to determine whether the small business qualifies for the loan product provided.

### CROSS-REFERENCE TO RELATED APPLICATION

This application claims priority to U.S. Provisional Application No. 61/776,250, filed Mar. 11, 2013, the entire contents of which is hereby incorporated by reference.

### BACKGROUND

### Field

Obtaining financing is often difficult for small businesses. The process often contains several manual steps, requires significant time and resource commitments from both the small business as well as the lender, and relies on suboptimal and poorly available information. While information aggregators, such as credit bureaus, help meet many credit information needs for consumer lenders, the coverage and reliability of these institutions is poor when it comes to small businesses. Furthermore, traditional metrics such as repayment history are much less relevant indicators of small business creditworthiness than indicators addressing the fundamental health of the borrower's business.

Because of these challenges, small business borrowing needs are only partially met by existing solutions. Moreover, lenders may find it easier to dismiss loans to smaller businesses as not being worth the time and resource investments because easily accessible data that could form a basis for automated decisioning is not available.

The disclosed embodiments include methods and systems that address the challenges associated with small business loans. In one embodiment, small business data collection, loan preapproval, loan application, and loan management processes may be provided through a central resource that enables businesses to provide digitally available indicators of their business health for consideration by lenders, and where a lender can identify and target loan offers to registered and potentially preapproved businesses. In one aspect, an online lender service may be provided that allows businesses to integrate their business data with a financial service provider for efficient and sometimes automated loan approval, processing, and disbursement. The disclosed embodiments may be configured to receive and consider, via the service, business data from new data sources, including but not limited to, sales transactions, consumer reviews, expense information, payment metrics, salary and payroll information, tax information, growth and business cyclicality measures, etc.

In certain embodiments, businesses may register (e.g., sign up) directly with a lender system that may use Data Mart technologies to provide a variety of lending solutions. For example, the disclosed embodiments may provide methods and systems that generate standby lines of credit for consumers, which approved small businesses can instantly apply for and receive funds to cover periodic cash flow needs, such as working capital requirements for payroll, invoices, leases, etc. Other aspects of the disclosed embodiments are set forth below in this disclosure.

### SUMMARY

The disclosed embodiments include a system for providing an aggregated financial service account. In one embodiment, the system may include one or more memory devices storing software instructions and one or more processors configured to execute the software instructions to register a small business with a lending service provided by a lending system. The one or more processors may also be configured to receive first small business data from the small business, store the first small business data, and analyze the first small business data to determine whether the small business qualifies for a loan product provided by a financial service provider. The one or more processors may also be configured to determine, based on the analysis, that additional small business data is needed to determine whether the small business qualifies for the loan product, and receive second small business data from the small business. The one or more processors may analyze the second small business data to determine whether the small business qualifies for the loan product provided and provide a notification that the small business qualifies for the loan product. In certain aspects, the one or more processors may perform loan management processes associated with the loan product.

The disclosed embodiments may also include a computer-implemented method for providing an aggregated financial service account. The method may include, for example, registering a small business with a lending service provided by a lending system, receiving first small business data from the small business, and storing the first small business data. The method may also include analyzing the first small business data to determine whether the small business qualifies for a loan product provided by a financial service provider and determining, based on the analysis, that additional small business data is needed to determine whether the small business qualifies for the loan product. In certain aspects, the method may include receiving second small business data from the small business, and analyzing the second small business data to determine whether the small business qualifies for the loan product provided. Further, the method may include providing a notification that the small business qualifies for the loan product; and performing loan management processes associated with the loan product.

Although the disclosed embodiments are discussed primarily in the context of small business loan products (e.g., small business loan accounts, lines of credit, etc.), the disclosed embodiments are not limited to such products or types of consumers. For example, the disclosed embodiments may be also used in connection with other types of financial accounts, such as bank accounts (e.g., savings, checking, etc.), and with other types of consumers (e.g., large businesses, individuals, organizations, government agencies, etc.).

It is to be understood that both the foregoing general description and the following detailed description are exemplary and explanatory only and are not restrictive of the disclosed embodiments, as claimed.

The accompanying drawings, which are incorporated in and constitute a part of this specification, illustrate disclosed embodiments and, together with the description, serve to explain the disclosed embodiments.

### BRIEF DESCRIPTION OF THE DRAWINGS

FIG. 1 is a block diagram of an exemplary system consistent with disclosed embodiments.

FIG. 2 is a block diagram of another exemplary system, consistent with disclosed embodiments.

FIG. 3 is a block diagram of an exemplary financial service provider system, consistent with disclosed embodiments.

FIG. 4 is a block diagram of an exemplary lending system, consistent with disclosed embodiments.

FIG. 5 is a block diagram of an exemplary small business system, consistent with disclosed embodiments.

FIG. 6 is a block diagram of another exemplary system, consistent with disclosed embodiments.

FIG. 7 is a block diagram of an exemplary lending system and small business system arrangement, consistent with disclosed embodiments.

FIG. 8 is a flowchart of an exemplary lender search process, consistent with disclosed embodiments.

FIG. 9 is a flowchart of an exemplary lender service registration process, consistent with disclosed embodiments.

FIG. 10 is a flowchart of an exemplary data source collection process, consistent with disclosed embodiments.

FIG. 11 is a flowchart of an exemplary loan generation process, consistent with disclosed embodiments.

FIG. 12 is a flowchart of an exemplary loan application process, consistent with disclosed embodiments.

FIG. 13 is a flowchart of an exemplary loan management process, consistent with disclosed embodiments.

FIG. 14 is a diagram of an exemplary lender service interface, consistent with disclosed embodiments.

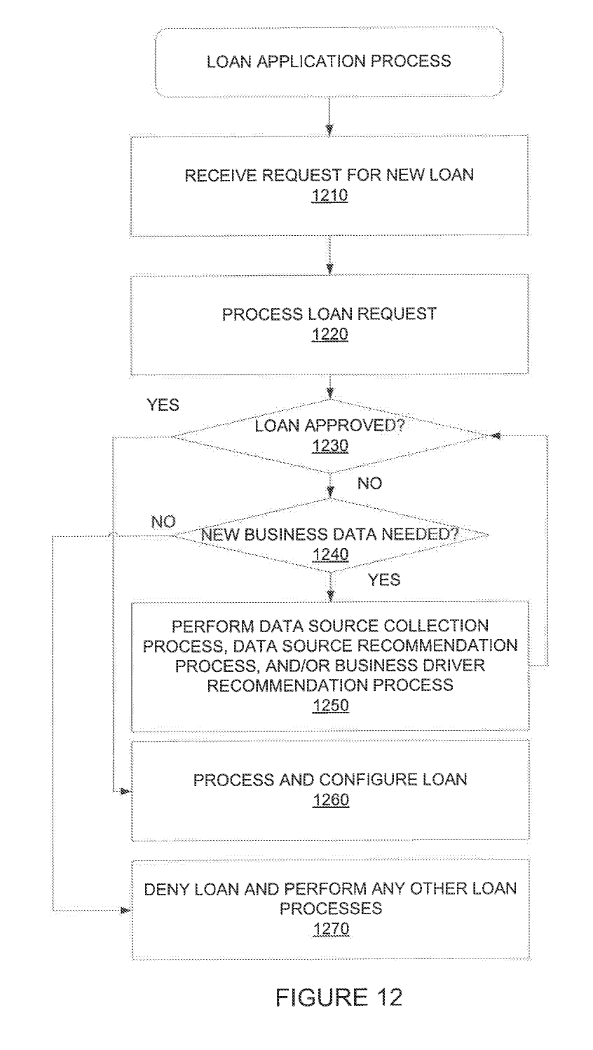

FIG. 12 is a diagram of an exemplary available loan products interface, consistent with disclosed embodiments.

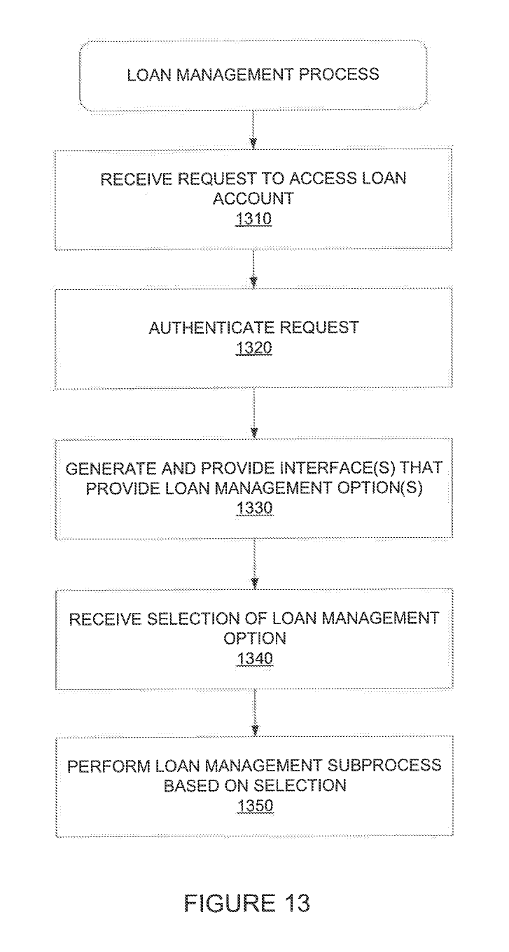

FIG. 13 is a diagram showing exemplary active loan and standby loan interfaces, consistent with disclosed embodiments.

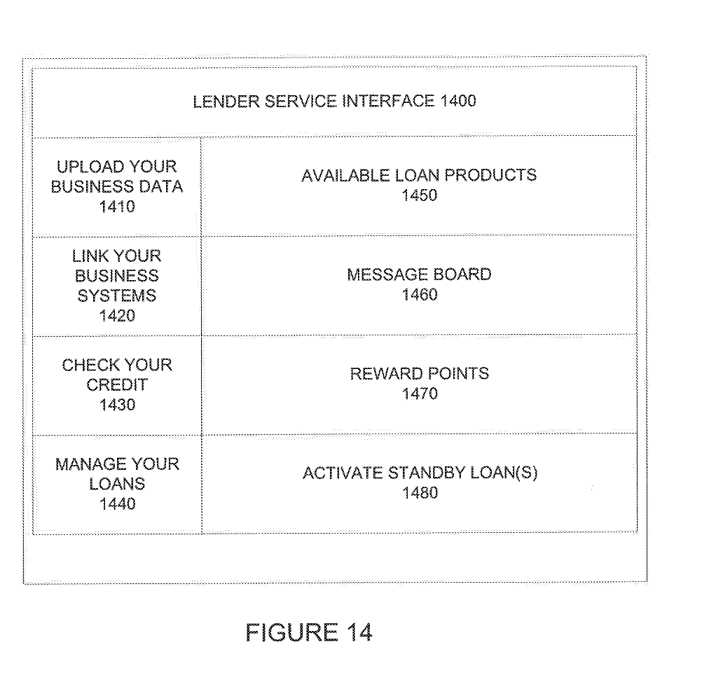

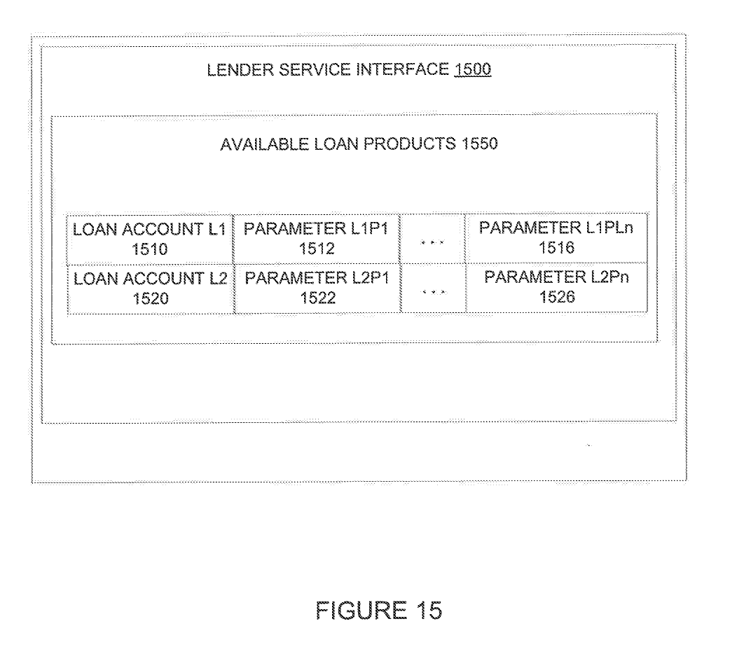

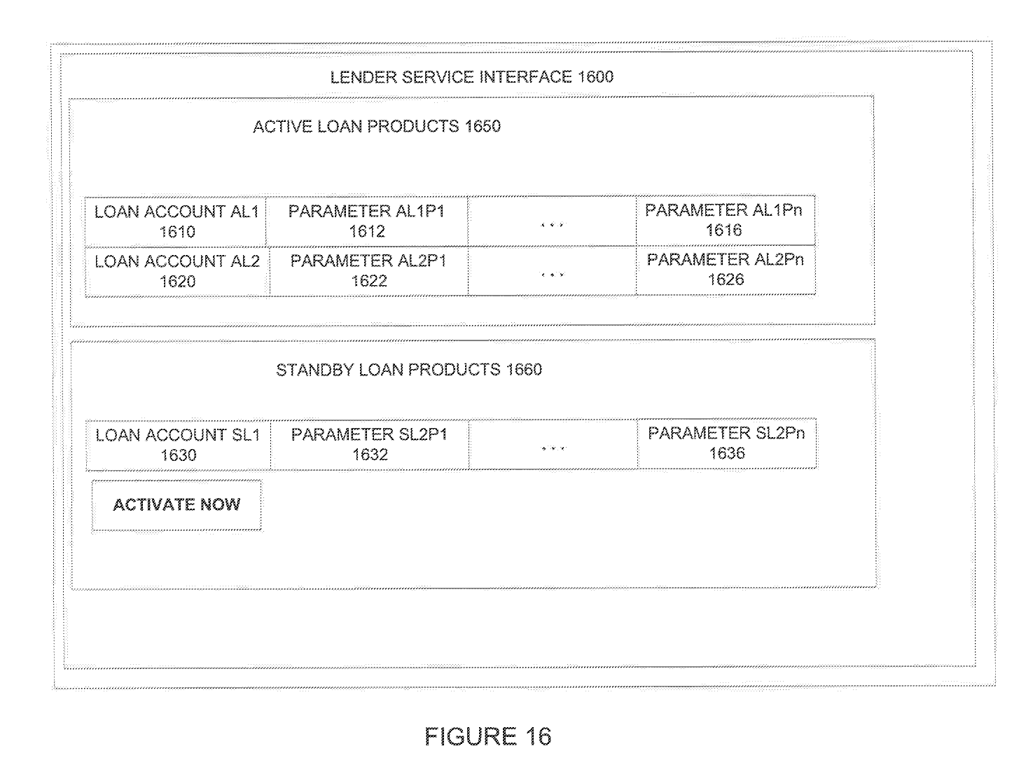

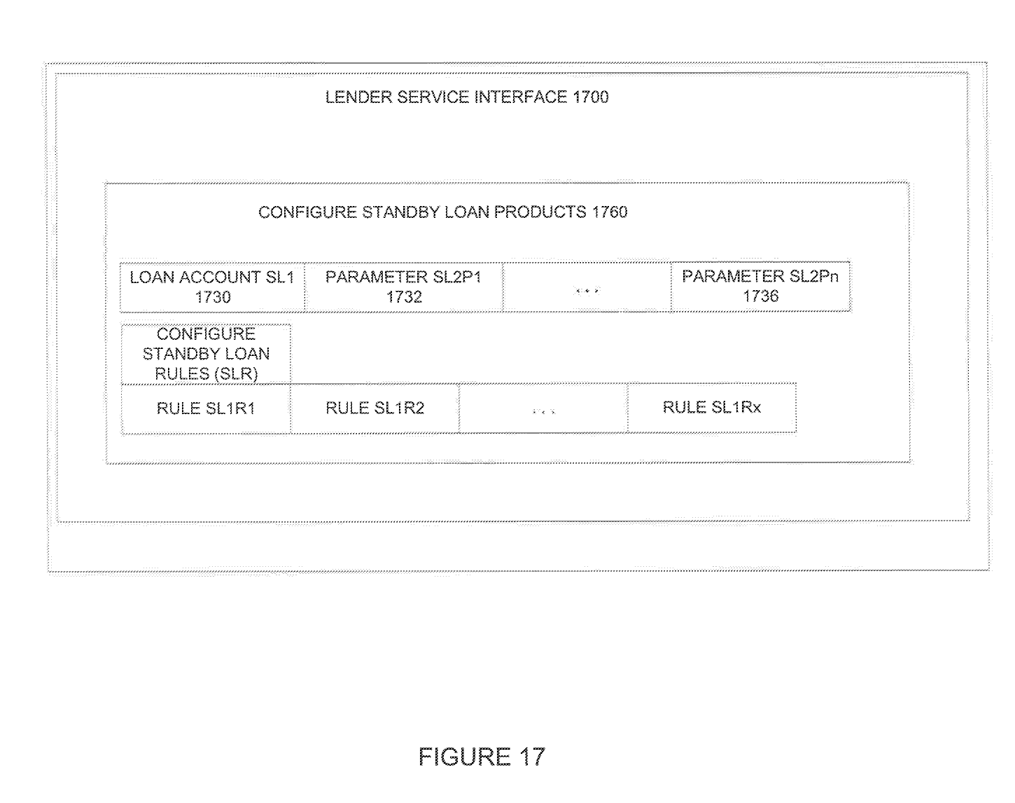

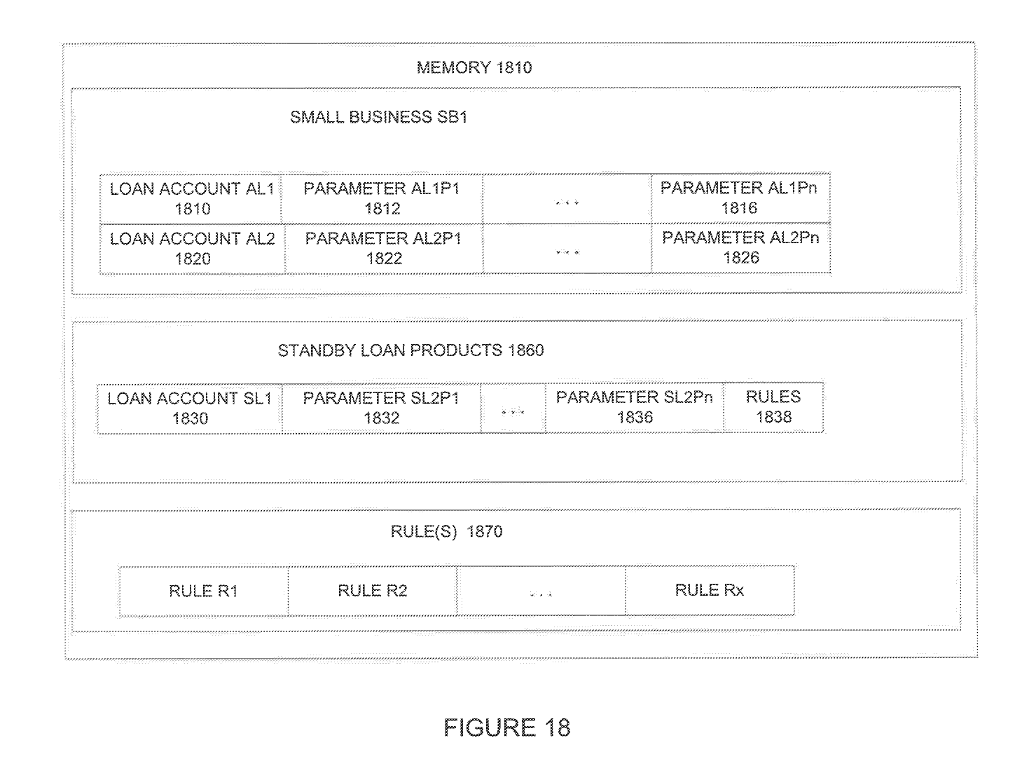

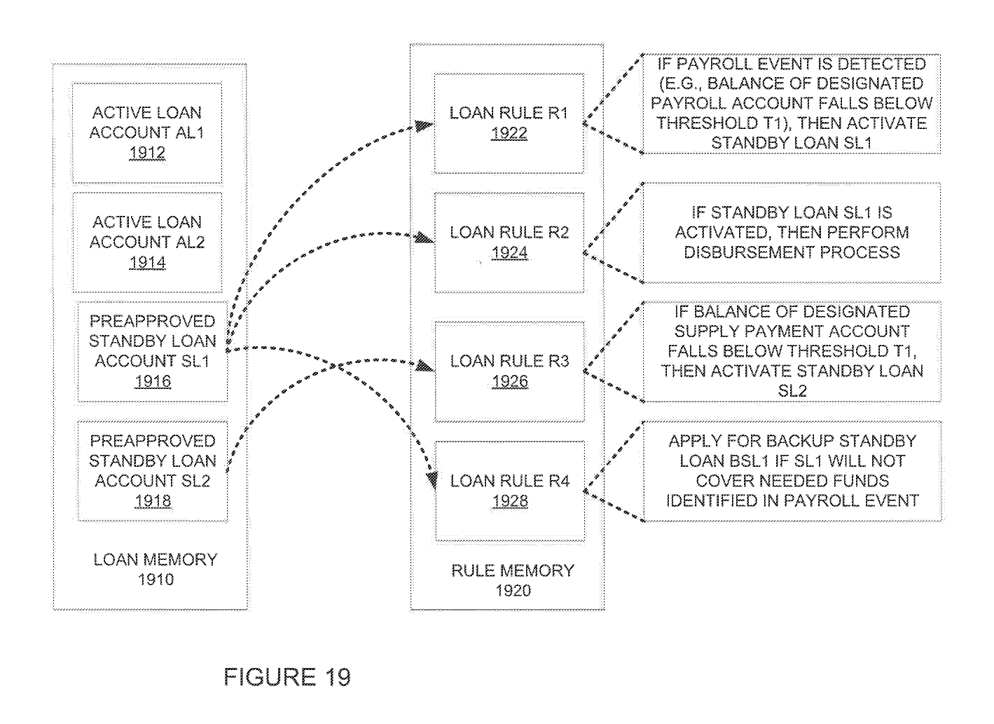

FIG. 14 is a diagram of an exemplary loan management interface, consistent with disclosed embodiments.

FIG. 15 is a diagram of an exemplary available loan products interface, consistent with disclosed embodiments.

FIG. 16 is a diagram of an exemplary active and standby loan product interface, consistent with disclosed embodiments.

FIG. 17 is a diagram of an exemplary loan product configuration interface, consistent with disclosed embodiments.

FIG. 18 is a diagram of an exemplary loan information data structure, consistent with disclosed embodiments.

FIG. 19 is a diagram showing exemplary loan data and loan rule relationships, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

The disclosed embodiments include methods, systems, and articles of manufacture that are configured to provide, for example, loan generation, application, disbursement, and management processes. In certain aspects, a financial service provider, such as a bank, may implement components that are configured to collect business data from small business entities and store the data in memory. Based on the collected business data, the financial service provider (via, for example, computing components) may determine one or more loan products that may be offered and provided to qualifying small businesses. The disclosed embodiments may perform loan assessment, approval, and management operations automatically based on predetermined rules and the business data provided by the small businesses. In certain aspects, the disclosed embodiments may automatically analyze the business data submitted by a small business to determine whether new business data is needed for processing and possibly approving a loan. In other aspects, a small business may link its business and financial software to the lending service such that the small business may send business data for automatic storage in a database system used by the financial service provider to assess loan products for the small business. The disclosed embodiments may generate and provide recommendations to a small business regarding the type of business data that should be uploaded for assessment. The suggestions may identify data that may give the small business a better opportunity for being approved for a loan. Other aspects of the disclosed embodiments are disclosed below and the above examples are not intended to be limiting.

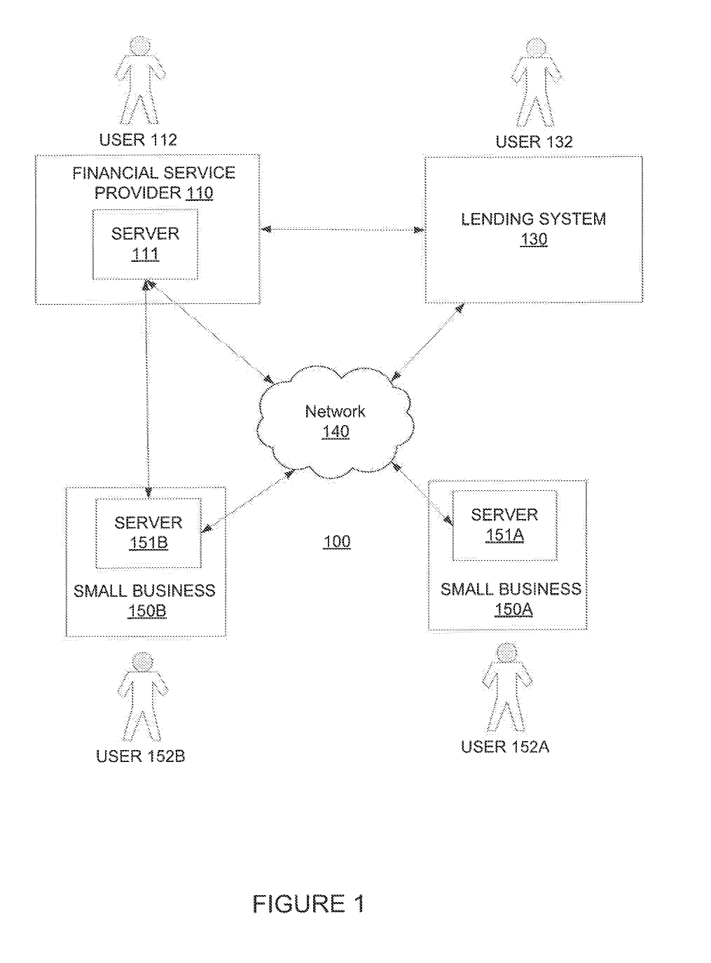

FIG. 1 is a block diagram of an exemplary system 100 for performing one or more operations consistent with the disclosed embodiments. In one embodiment, system 100 may include a financial service provider 110, lending system 130, one or more small businesses 150 (exemplary small businesses 150A and 150B shown), and network 140. The components and arrangement of the components included in system 100 may vary. Thus, system 100 may further include other components that perform or assist in the performance of one or more processes consistent with the disclosed embodiments.

Financial service provider 110 may be an entity that provides financial services. For example, financial service provider 110 may be a bank, credit card issuer, or other type of financial service entity that generates, provides, manages, and/or maintains financial service accounts for one or more users. Financial service accounts may include, for example, credit card accounts, loan accounts, checking accounts, savings accounts, reward accounts, and any other types of financial service account known to those skilled in the art. In certain embodiments, financial service provider 110 may be a lender that provides one or more types of loans for business and/or individuals. For purposes of explanation only, financial service provider 110 is described as an entity that may offer and manage business loans for small businesses. Financial service provider 110 may include infrastructure and components that are configured to generate and provide financial service accounts such as lines of credit, capital loans, and the like.

In one embodiment, financial service provider 110 may include one or more computing systems that are configured to execute software instructions stored on one or more memory devices to perform one or more operations consistent with the disclosed embodiments. In one embodiment, financial service provider 110 may include server 111. Server 111 may be one or more computing devices configured to execute software instructions stored in memory to perform one or more processes consistent with the disclosed embodiments. For example, server 111 may include one or more memory device(s) storing data and software instructions and one or more processor(s) configured to use the data and execute the software instructions to perform server-based functions and operations known to those skilled in the art. Server 111 may also be configured to execute stored software instructions to perform operations associated with aggregating and managing multiple private label financial service accounts in a manner consistent with the disclosed embodiments. Server 111 may be a general purpose computer, a mainframe computer, or any combination of these components. In certain embodiments, server 111 (or a system including server 111) may be configured as a particular apparatus, system, and the like based on the storage, execution, and/or implementation of the software instructions that perform one or more operations consistent with the disclosed embodiments. Server 111 may be standalone, or it may be part of a subsystem, which may be part of a larger system. For example, server 111 may represent distributed servers that are remotely located and communicate over a network (e.g., network 140) or a dedicated network, such as a LAN, for financial service provider 110.

Server 111 may include or may connect to one or more storage devices configured to store data and/or software instructions used by one or more processors of server 111 to perform operations consistent with disclosed embodiments. For example, server 111 may include memory configured to store one or more software programs that performs several functions when executed by a processor. The disclosed embodiments are not limited to separate programs or computers configured to perform dedicated tasks. For example, server 111 may include memory that stores a single program or multiple programs. Additionally, server 111 may execute one or more programs located remotely from server 111. For example, server 111 may access one or more remote programs stored in memory included with a remote component that, when executed, perform operations consistent with the disclosed embodiments. In certain aspects, server 111 may include web server software that generates, maintains, and provides web site(s) that are accessible over network 140. In other aspects, financial server provider 110 may connect separate web server(s) or similar computing devices that generate, maintain, and provide web site(s) for financial service provider 110.

In certain aspects, a user 112 may operate one or more components of financial service provider 110 (e.g., server 111) to perform one or more operations consistent with the disclosed embodiments. In one aspect, user 112 may be an employee of, or associated with, financial service provider 110 (e.g., someone authorized to use components of server 111 or perform processes for financial service provider 110). In other aspects, user 112 may not be an employee of, or otherwise is associated with financial service provider 110.

Small businesses 150A and 150B may business entities that perform some business. As disclosed herein, a small business may be generally referred to as small business 150. One of ordinary skill in the art would realize that a reference to small business 150 may refer to small business 150A, small business 150B, or both. While aspects of the disclosed embodiments are described in connection with two small businesses 150A and 150B, the disclosed embodiments may be implemented in a system including only one small business 150 or more than two small businesses 150. Moreover, while aspects of the disclosed embodiments are described in connection with a small business 150, the disclosed embodiments may be implemented in configurations where small business 150 is not a small business but rather a large business, an individual, a non-profit based organization, a profit-based organization, a government agency, or any other type of entity or individual (or groups of individuals) that may request, receive, access, manage, or the like, financial services from financial service provider 110. Further, small business 150 is not limited to conducting business in any particular industry or field. For example, small business 150A may be a company that manufactures semiconductor chips and small business 150B may be a company that supplies automobile parts. The type, configuration, and size of small business 150 is not limiting to the disclosed embodiments.

Small business 150 may include brick and mortar location(s) that a consumer (e.g., user 152) may physically visit and purchase goods and services. Such physical locations may include computing devices that perform financial service transactions with consumers (e.g., POS terminal(s), kiosks, etc.). They may also include back and/or front-end computing components that store data and execute software instructions to perform operations consistent with disclosed embodiments, such as computers that are operated by employees of small business 150 (e.g., back office systems, etc.). In certain embodiments, small business 150 may also include small businesses that provide electronic shopping mechanisms, such as a website or similar online location that consumers may access using a computer through browser software or similar software.

In one embodiment, small businesses 150A and 150B include servers 151A and 151B, respectively. Server 151 may be one or more computing devices configured to execute software instructions stored in memory to perform one or more processes consistent with the disclosed embodiments. For example, server 151 may include one or more memory device(s) storing data and software instructions and one or more processor(s) configured to use the data and execute the software instructions to perform server-based functions and operations known to those of ordinary skill in the art. Server 151 may also be configured to execute stored software instructions to perform operations associated with merchant 150, including one or more processes associated with accounting, business forecasting, supply chain management, customer relationship management, and providing business data to financial service provider 110 for loan and credit assessments. Server 151 may be a general purpose computer, a mainframe computer, or any combination of these components. In certain embodiments, server 151 (or a system including server 151) may be configured as a particular apparatus, system, and the like based on the storage, execution, and/or implementation of the software instructions that perform one or more operations consistent with the disclosed embodiments. Server 151 may be standalone, or it may be part of a subsystem, which may be part of a larger system. For example, server 151 may represent distributed servers that are remotely located and communicate over a network (e.g., network 140) or a dedicated network, such as a LAN, for small business 150.

In certain aspects, server 151 may include web server software that generates, maintains, and provides web site(s) for a respective small business 150 that is accessible over network 140. In other aspects, small business 150 may connect to separate to web server(s) or similar computing devices that generate, maintain, and provide web site(s) for small business 150. For example, small business 150A may include, use, or connect to one or more web server(s) that provide a web site specific to small business 150A that allows consumers to access, view, and purchase goods and/or services from small business 150A.

In certain embodiments, one or more users may operate components associated with small business 150 to perform one or more processes consistent with the disclosed embodiments. For example, user 152A may access, use, and otherwise operate server 151A of small business 150A to perform processes such as purchase or sale transaction processes, forecasting processes, supply chain management processes, inventory management processes, accounting processes, and the like. User 152B may also access, use, and otherwise operate server 151B of small business 150B to perform similar processes associated with the business for small business 150B.

In one example, user 152A may be a user that runs business software executed by computing components of small business 150A (e.g., server 151A) and can work with the computing components to provide business data to financial service provider 110 or lending system 130 over network 140.

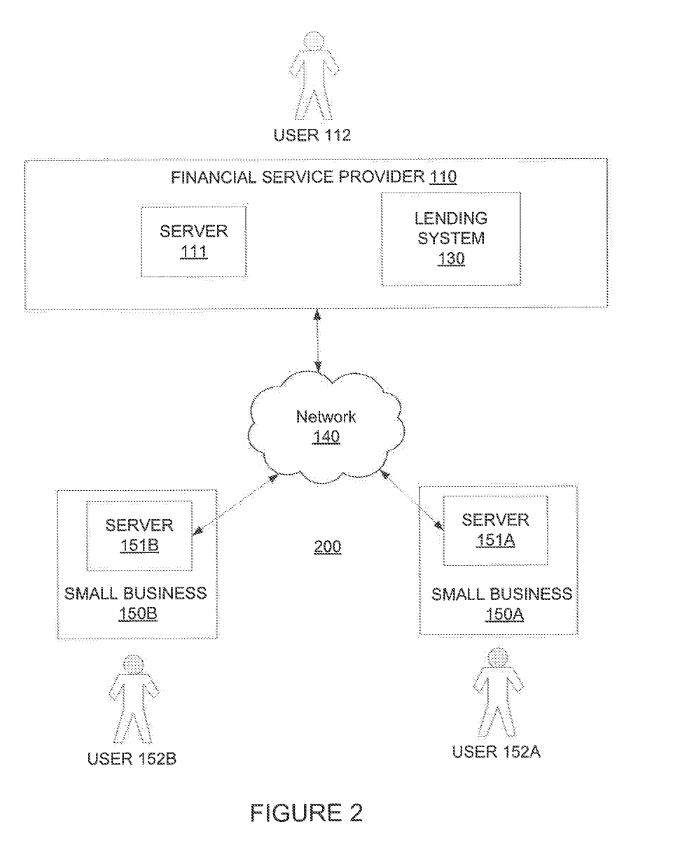

Lending system 130 may be a computing system configured to perform one or more lending processes consistent with disclosed embodiments. User 132 may operate lending system 130, or components of lending system 130, that perform one or more operations for processing, managing, approving, assessing, and maintaining financial accounts, such as loan products (e.g., line of credit, etc.). Lending system 130 may be associated with an entity (e.g., lender entity) that provides loan services, including assessing and providing loans. The lender entity may be a company, individual, or other type of entity that provides lender system 130. In other embodiments, lending system 130 may be included with financial service provider 110. FIG. 2 shows a block diagram of an exemplary system 200 where lending system 130 is part of financial service provider 110. The disclosed embodiments are not limited to the affiliations between lending system 130 (or the lending entity that provided lending system 130), financial service provider 110, and/or small businesses 150A and 150B.

In certain aspects, lending system 130 may include components that provide an online portal that provides a mechanism for small businesses 150 to request and send data that is used for performing one or more operations of the disclosed embodiments. Lending system 130 may include one or more web servers that generate, maintain, and manage web site pages that provide interfaces that are accessed by users, such as users 152A and/or 152B, using browser software executing in the computing components of server 151.

Network 140 may be any type of network configured to provide communications between components of system 100. For example, network 100 may be any type of network (including infrastructure) that provides communications, exchanges information, and/or facilitates the exchange of information, such as the Internet, a Local Area Network, or other suitable connection(s) that enables the sending and receiving of information between the components of system 100. In other embodiments, one or more components of system 100 may communicate directly through a dedicated communication link(s), such as the exemplary links between financial service provider 110 and small business 150B and between financial service provider 110 and lending system 130.

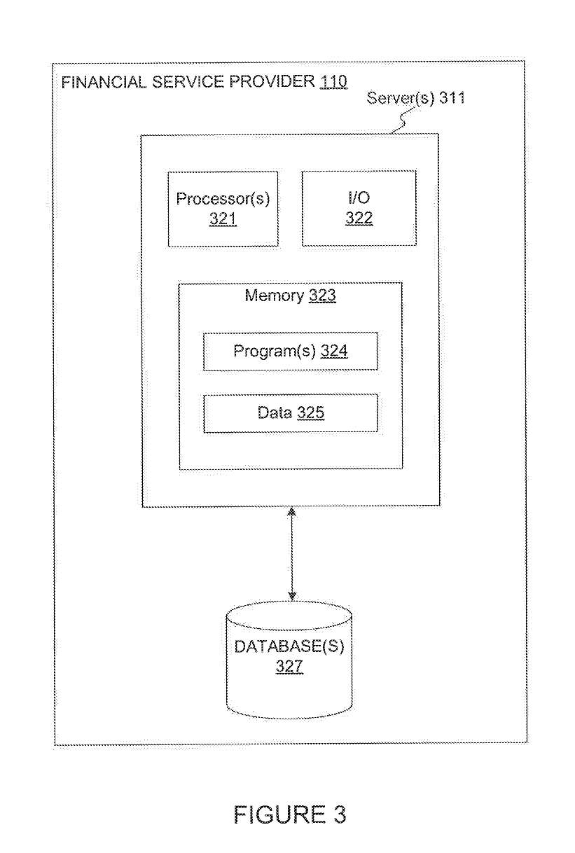

FIG. 3 shows an exemplary system that may be associated with financial service provider 110. In one embodiment, the system may include server(s) 311 having one or more processors 321, one or more memories 323, and one or more input/output (I/O) devices 322. Alternatively, server(s) 311 may take the form of a general purpose computer, a mainframe computer, or any combination of these components. In certain embodiments, server 311 (or a system including server 311) may be configured as a particular apparatus, system, and the like based on the storage, execution, and/or implementation of the software instructions that perform one or more operations consistent with the disclosed embodiments. Server 311 may be standalone, or it may be part of a subsystem, which may be part of a larger system. Server 311 may correspond to server 111 shown in FIG. 1 and described above in connection with system 100.

Processor(s) 321 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in server 311.

Memory 323 may include one or more storage devices configured to store instructions used by processor(s) 321 to perform functions related to disclosed embodiments. For example, memory 323 may be configured with one or more software instructions, such as program(s) 324 that may perform one or more operations when executed by processor(s) 321. The disclosed embodiments are not limited to separate programs or computers configured to perform dedicated tasks. For example, memory 323 may include a single program 324 that performs the functions of the server 311, or program 324 could comprise multiple programs. Additionally, processor(s) 321 may execute one or more programs located remotely from server 311. For example, financial service provider 110, via server 311, may access one or more remote programs that, when executed, perform functions related to certain disclosed embodiments.

Memory 323 may also store data 325 that may reflect any type of information in any format that financial service provider 110 may use to perform financial service provider functions. For example, data 325 may include business records associated with customers of financial service provider 110 (e.g., small businesses 150A and/or 150B).

I/O devices 322 may be one or more devices configured to allow data to be received and/or transmitted by server(s) 311. I/O devices 322 may include one or more digital and/or analog communication devices that allow server(s) 311 to communicate with other machines and devices, such as servers 151A and 151B of small businesses 150A and 150B, respectively.

Server(s) 311 may also be communicatively connected to one or more database(s) 327. Server(s) 311 may be communicatively connected to database(s) 327 through network 140. Database(s) 327 may include one or more memory devices that store information and are accessed and/or managed through server(s) 311. By way of example, database(s) 327 may include Oracle™ databases, Sybase™ databases, or other relational databases or non-relational databases, such as Hadoop sequence files, HBase, or Cassandra. Database(s) 327 or other files may include, for example, data and information related to the source and destination of a network request, the data contained in the request, etc. Systems and methods of disclosed embodiments, however, are not limited to separate databases. In one aspect, financial service provider 110 may include database(s) 327. Alternatively, one or more database(s) 327 may be located remotely from financial service provider 110. Database(s) 327 may include computing components (e.g., database management system, database server, etc.) configured to receive and process requests for data stored in memory devices of database(s) 327 and to provide data from database(s) 327.

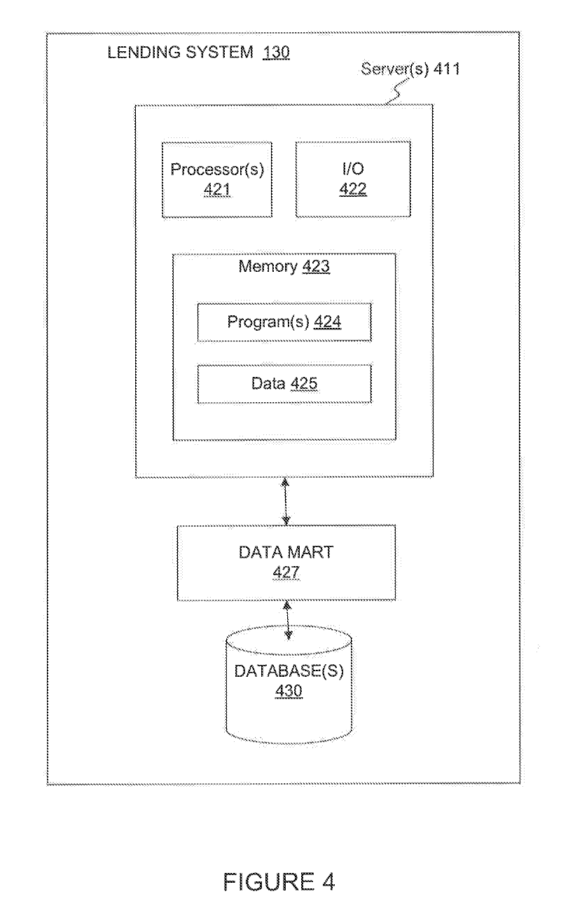

FIG. 4 shows an exemplary system that may be associated with lending system 130. In one embodiment, the system may include server(s) 411 having one or more processor(s) 421, one or more memories 423, and one or more input/output (I/O) devices 422. Alternatively, server(s) 411 may take the form of a general purpose computer, a mainframe computer, or any combination of these components. In certain embodiments, server(s) 411 (or a system including server(s) 411) may be configured as a particular apparatus, system, and the like based on the storage, execution, and/or implementation of the software instructions that perform one or more operations consistent with the disclosed embodiments. Server(s) 411 may be standalone, or it may be part of a subsystem, which may be part of a larger system.

Processor(s) 421 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in server(s) 411.

Memory 423 may include one or more storage devices configured to store instructions used by processor(s) 421 to perform functions related to disclosed embodiments. For example, memory 423 may be configured with one or more software instructions, such as program(s) 424 that may perform one or more operations when executed by processor(s) 421. The disclosed embodiments are not limited to separate programs or computers configured to perform dedicated tasks. For example, memory 423 may include a single program(s) 424 that performs the functions of server(s) 411, or program(s) 424 could comprise multiple programs. Additionally, processor(s) 421 may execute one or more programs located remotely from server(s) 411. For example, lending system 130, via server(s) 411, may access one or more remote programs that, when executed, perform functions related to certain disclosed embodiments. In certain aspects, program(s) 424 may include software instructions that, when executed by processor(s) 421, perform lending service processes consistent with the disclosed embodiments, such as collecting business data from small businesses 150, assessing loan applications, approving loan application, providing disbursements, generating recommendations for additional business data or adjustments to business drivers to help small businesses 150 get approved for small business loans offered by financial service provider 110.

Lending system 130 may include software that operates as a web server to provide web site(s) and web page(s) that include interfaces accessed by components of small business 150 (e.g., server 151) through the direction of user 152 or automated software processes. In one embodiment, lending system 130 is configured to provide an online lending service that consumers (e.g., small business 150) may access via network 140 to request loans, manage existing loans, view information relating to loan accounts with financial service provider 110, and upload business data. Lending system 130 may also include computing components that are configured to communicate with small business 150 that have registered with the online lending service to exchange business information through known business software communication mechanisms, including secure Internet-related communications, EDI, and any other type of communication link and protocols.

Memory 423 may also store data 425 that may reflect any type of information in any format that financial service provider 110 may use to perform financial service provider functions. For example, data 425 may include business records associated with customers of financial service provider 110 (e.g., small businesses 150A and/or 150B).

I/O devices 422 may be one or more devices configured to allow data to be received and/or transmitted by server(s) 411. I/O devices 422 may include one or more digital and/or analog communication devices that allow server(s) 411 to communicate with other machines and devices, such as servers 151A and 151B of small businesses 150A and 150B, respectively.

Server(s) 411 may also be communicatively connected to one or more database(s) 430. Server(s) 411 may be communicatively connected to database(s) 430 through network 140. Database(s) 430 may include one or more memory devices that store information and are accessed and/or managed through server(s) 411. By way of example, database(s) 411 may include Oracle™ databases, Sybase™ databases, or other relational databases or non-relational databases, such as Hadoop sequence files, HBase, or Cassandra. Database(s) 430 or other files may include, for example, data and information related to the source and destination of a network request, the data contained in the request, etc. Systems and methods of disclosed embodiments, however, are not limited to separate databases. In one aspect, lending system 130 may include database(s) 430. Alternatively, one or more database(s) 430 may be located remotely from lending system 130. Database(s) 430 may include computing components (e.g., database management system, database server, etc.) configured to receive and process requests for data stored in memory devices of database(s) 430 and to provide data from database(s) 430. Lending system 130 may also include a data mart 427 that is configured to provide, control, and manage access to data stored in database(s) 430. Data mart 427 may be configured to execute known data mart functions and operations.

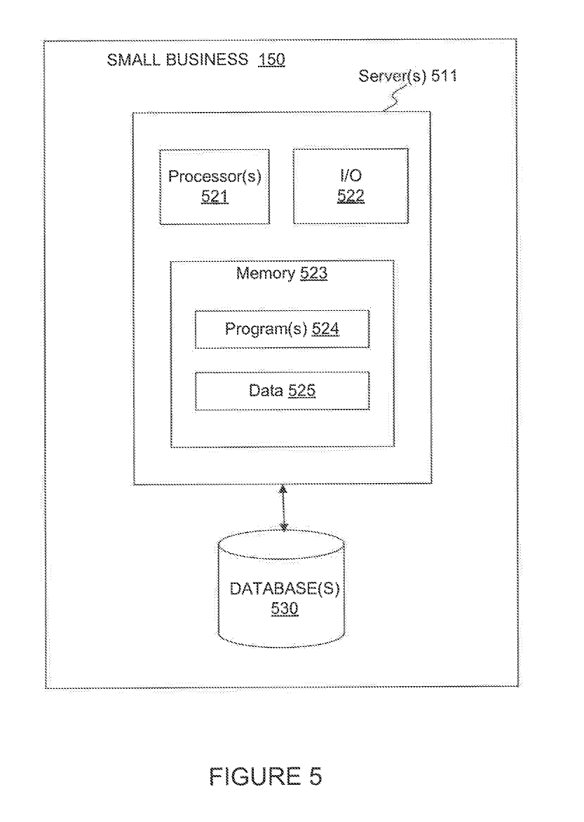

FIG. 5 shows an exemplary system that may be associated with small business 150 (e.g., small business 150A or 150B). In one embodiment, the system may include server(s) 511 having one or more processor(s) 521, one or more memories 523, and one or more input/output (I/O) devices 522. Alternatively, server(s) 511 may take the form of a general purpose computer, a mainframe computer, or any combination of these components. In certain embodiments, server(s) 511 (or a system including server(s) 511) may be configured as a particular apparatus, system, and the like based on the storage, execution, and/or implementation of the software instructions that perform one or more operations consistent with the disclosed embodiments. Server(s) 511 may be standalone, or it may be part of a subsystem, which may be part of a larger system. Server(s) 511 may correspond to server 151 (e.g., server 151A or 151B) shown in FIG. 1 and described above in connection with system 100.

Processor(s) 521 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in server(s) 511.

Memory 523 may include one or more storage devices configured to store instructions used by processor(s) 521 to perform functions related to disclosed embodiments. For example, memory 523 may be configured with one or more software instructions, such as program(s) 524, that may perform one or more operations when executed by processor(s) 521. The disclosed embodiments are not limited to separate programs or computers configured to perform dedicated tasks. For example, memory 523 may include a single program(s) 524 that performs the functions of server(s) 511, or program(s) 524 could comprise multiple programs. Additionally, processor(s) 521 may execute one or more programs located remotely from server(s) 511. For example, small business 150, via server(s) 511, may access one or more remote programs that, when executed, perform functions related to certain disclosed embodiments.

Memory 523 may also store data 525 that may reflect any type of information in any format that small business 150 may use to perform operations consistent with the type of business affiliated with small business 150.

I/O devices 522 may be one or more devices configured to allow data to be received and/or transmitted by server(s) 511. I/O devices 522 may include one or more digital and/or analog communication devices that allow server(s) 511 to communicate with other machines and devices.

Server(s) 511 may also be communicatively connected to one or more database(s) 530. Server(s) 511 may be communicatively connected to database(s) 530 through network 140. Database(s) 530 may include one or more memory devices that store information and are accessed and/or managed through server(s) 511. By way of example, database(s) 530 may include Oracle™ databases, Sybase™ databases, or other relational databases or non-relational databases, such as Hadoop sequence files, HBase, or Cassandra. Database(s) 530 or other files may include, for example, data and information related to the source and destination of a network request, the data contained in the request, etc. Systems and methods of disclosed embodiments, however, are not limited to separate databases. In one aspect, small business 150 may include database(s) 530. Alternatively, database(s) 530 may be located remotely from small business 150. Databases 530 may include computing components (e.g., database management system, database server, etc.) configured to receive and process requests for data stored in memory devices of database(s) 530 and to provide data from database(s) 530.

The disclosed embodiments are configured to allow small business 150 to communicate with lending system 130 and financial service provider 110. In certain aspects, financial service provider 110 may need to assess the credit worthiness of small business 150 to determine whether to provide a loan to the business.

In certain aspects, the disclosed embodiments enable small business 150 to register with a lending service provided by lending system 130 to provide business loan processes. In order for lending system 130 to perform loan processes for small business 150, lending system 130 may require certain types of information about the health of the small business. The disclosed embodiments provide methods and systems for registering a small business 150 with a lending service, and for providing mechanisms that allows the registered small business 150 to exchange information with lending system 130 that can be used by financial service provider 110 to determine, assesses, generate, approve, process, and manage loan products for the small business 150. In one embodiment, small business 150 may execute software instructions, e.g., via processor(s) 521, that automatically collect business data from data sources and upload the business data to lending system 130 over network 140 or other communication links. In other embodiments, small business 150 may provide business data to lending system 130 through a portal associated with the lending service. In another embodiment, lending system 130 may execute loan processes that allow a small business to be preapproved for standby loan products, which may be financial loan accounts that can be activated upon request by a user (e.g., user 152 of small business 150) or automatically activated based on conditions and rules in software instructions executed by lending system 130, server 111 of financial service provider 110, and/or server 151 of small business 150.

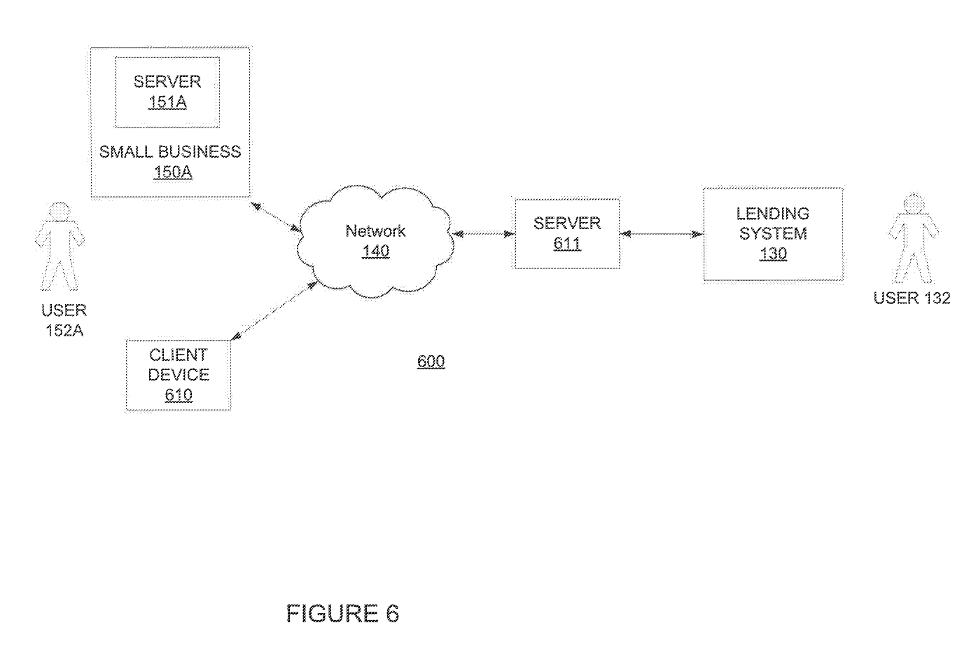

FIG. 6 shows a block diagram of an exemplary arrangement 600 for exchanging data between small business 150 and lending system 130. As shown in this example, user 152A may operate client device 610 or computing components of small business 150A (e.g., server 151A, server(s) 511 of FIG. 5, etc.) to generate requests for business data associated with small business 150A. The business data requests may be processed by, for example, server 151A or server(s) 511, to identify, collect and prepare business data for transmission to lending system 130. Business data requests may originate in response to software instructions executing by server 151A or server(s) 511. The software instructions, when executed, may automatically search and store business data at determined memory locations, memory queues, buffers, or any other type of memory storage that can be used to store information.

Client device 610 may be one or more computing devices that include one or more processor(s) and memory devices that store data and software instructions that may be executed by the processor(s). Client device may be, for example, a laptop, desktop computer, mobile device (tablet, smart phone, etc.), server, mainframe, or any other type of computing device. User 152A may operate client device 610 to perform one or more operations similar to those performed by server 151A or server(s) 511. For example, user 152A may use client device 610 to execute mobile applications (such as on a smart phone) that establishes communication links with lending system 130 and allows user 152A to select and upload business data over network 140.

Server 151A, server(s) 311A, and client device 160A may be configured to provide business data to lending system 130 using network 140. In the exemplary embodiment shown in FIG. 6, a server 611 may be implemented to provide a portal that provides an online location for user 152A, via server 151A, server(s) 311, or client device 160A, to access a lending service that provides functions for uploading business data from small business 150A. The disclosed embodiments may be implemented without server 611 or an online lending service portal, but instead may use other communication mechanisms for providing business data over network 140 to lending system 130. In certain embodiments, server 151A or server(s) 311 may execute software instructions that create packets of business data to send to lending system 130 in batches. Server 151A, server(s) 311, and/or client device 160A may send business data to lending system automatically, in response to commands from user 152A, periodically, or on-demand (e.g., in response to a request). The business data may include message packets that include business data associated with small business 150A.

In certain embodiments, small business 150 may generate and store business data in different formats and use the business data for different reasons. For example, small business 150A may generate and store accounting business data. Business data may come from one or more data sources associated with small business 150. Business data may include, but is not limited to, sales transactions, supply chain information, consumer reviews, expense information, payment metrics, shipping information, salary and payroll information, tax information, growth and business cyclicality measures, etc. Data sources of business data may include, but are not limited to, accounting software (e.g., Intuit Quickbooks, credit card transaction flows, shipping software or databases, direct deposit account databases, capital cash flow databases, and any other source that may include business data relating to the operation and business health of small business 150.

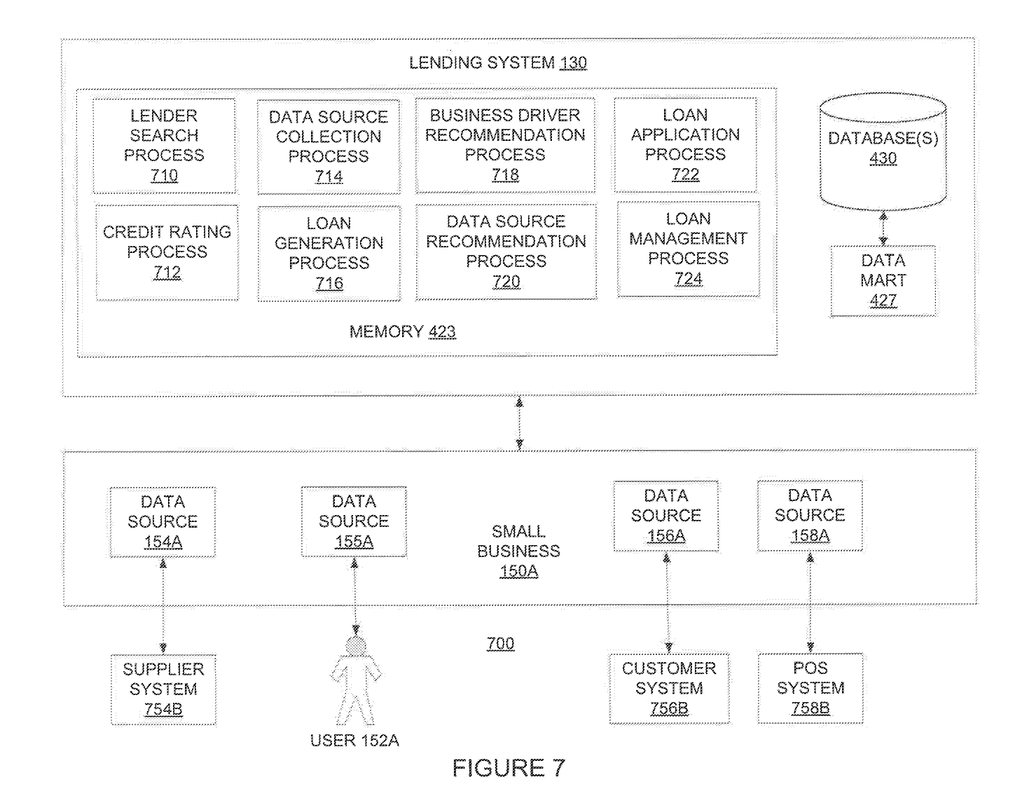

FIG. 7 shows a block diagram of an exemplary system 700 including data sources for small business 150A and of lender system 130, consistent with disclosed embodiments. Small business 150A may be connected to lending system 130 via a communication link, such as network 140, as shown in FIGS. 1 and 2. In one embodiment, small business 150A may include one or more data sources 154A, 155A, 156A, 158A that store business data that may be provided to lender system 130 for performing one or more operations consistent with the disclosed embodiments. Data sources 154A, 155A, 156A, 158A may be memory that stores information, such as business data. For example, data sources may be included in a single memory (e.g., memory 423, database(s) 430) or they may be stored separately or in combinations in different memory devices or locations. In other embodiments, data sources 154A, 155A, 156A, 158A may reflect locations of memory or may be associated with systems that include memory and other computing components (e.g., processors, etc.) that perform certain operations. For example, data source 154A may be associated with a supply chain software system that performs supplier related operations, such as handling supplier invoices, inventory, supply orders, etc. In other aspects, data source 154A may reflect a memory storing supplier related business data. Data source 154A, in one example, may include supplier business data (e.g., invoices, bill amounts for supplies, supplier account balances, forecasts for inventory, estimated and actual budget values, associated with supplier transactions. In certain aspects, a remote third party supplier system 754B may provide supplier business data that is stored in data source 154A.

As another example, data sources may include business data provided by a user entering information into a computing system or database. For instance, data source 155A may include business data provided by a user (e.g., user 152A) through input components (e.g., a keyboard, touch screen, etc.) to a computing system (e.g., server 151A, server(s) 511). User 152A may generate and provide different types of business data to data source 155A (or any data source in small business 150A), such as customer feedback reports, expense information, payment metrics, salary and payroll information, tax information, growth and business cyclicality measures, etc. User 152A may be a user associated with small business 150A (e.g., an employee of small business 150A) or may be a third party user who is not affiliated with small business 150A (e.g., a customer or supplier of small business 150A).

As another example, small business 150A may include data source 156A that includes customer information, such as consumer reviews, customer specific sales transaction information, budget information for customers of small business 150A, etc. In one embodiment, data source 156A may receive business data from a customer system 756B, which may be a computing system that is configured to provide business data to small business 150A over network 140 or another communication link. Small business 150A may execute software (e.g., via server 151A) that automatically requests, collects, and/or receives business data from customer system 756B and stores and configures the business data in data source 156A.

As a further example, small business 150A may include data source 158A that includes sales or purchase transaction data relating to sales associated with small business 150A. In one embodiment, a Point of Sale (POS) system 758B may provide transaction data as business data to data source 158A for storage. For example, POS 758B may be a POS or similar device associated with small business 150A that is configured to send sales transaction information to data source 158A periodically, on-demand, or based on scheduled events identified by software instructions executed by a processor.

The above description of data sources 154A, 155A, 156A, 158A is exemplary. The disclosed embodiments include embodiments that use any type of data source that may store any type of business data relating to small business 150A, such as general business health information (e.g., profit data, estimated expenses, budgets, actual expenses and budgets, consumer reviews, government reviews, and/or third party reviews such as reports provided by other entities that evaluate businesses or products, etc.). Further, the above descriptions of how business data is provided to data sources included in small business 150A is not limited to the examples set forth above.

In certain embodiments, lending system 130 may store software instructions that when executed by a processor(s) (e.g., processors(s) 421 of server(s) 411), perform one or more operations consistent with the disclosed embodiments. In one embodiment, lending system 130 may store one or more processes in a memory, e.g., memory 423, that are executed by one or more processors (e.g., processors(s) 421 of server(s) 411). In one example, memory 423 may include lender search process 710, credit rating process 712, data source collection process 714, loan generation process 716, business driver recommendation process 718, data source recommendation process 720, loan application process 722, and loan management process 724. The disclosed embodiments are not limited to these exemplary processes. One or more of the processes shown in FIG. 7 may be implemented, retrieved from, or stored in another location, such as memory remote from lending system 130. Further, other types of processes may be executed by lending system 130 consistent with the disclosed embodiments.

One or more of the processes 710-724 provided by lending system 130 may be performed through a lending service portal that is accessible by users over network 140 (e.g., an online portal accessible over the Internet). Further, one or more processes 710-724 may be performed through a local software program or application provided to a user (e.g., user 132). For example, lending system 130 may use a web server or similar computing device to provide a web site that provides interfaces to small businesses 150 that can be viewed and used by users (e.g., users 152). Lending system 130 may also execute database management software, including for example, data mart and data warehouse type business software, to allow users to request certain operations, view data, and provide data to components of lending system 130. One or more of processes 710-724 may use data mart 427 and database(s) 430 to request, search, and retrieve data for performing operations associated with a particular process.

As an example, lender search process 710 may be a process that may be performed by lending system 130 to identify one or more small businesses that meet certain criteria for loan products offered by financial service provider 110, or other entity, such as a lender. In one aspect, lending system 130, via a computing device (e.g., server(s) 411), generates and provides for display on a display device an interface that allows a user (e.g., user 132) to search for small businesses that meet selected criteria so that lending system 130 (or financial service provider 110) may offer loan products to the qualified small businesses 150. For example, lender search process 710 may provide an interface that requests a user to input search criteria associated with qualifying for one or more loan products (e.g., a line of credit, etc.). Lender search process 710 may receive the search request from a user and search database(s) 430 via data mart 427 to generate a report identifying any small business that may qualify for a particular loan product. The criteria used by lending system may vary. For instance, small business 150A may qualify for a $50,000 line of credit loan product if small business 150A has a certain debt to income/profit ratio. Other criteria may be combined to narrow or broaden the search to identify qualifying small businesses 150. The disclosed embodiments are not limited to the types of criteria. Also, lending system 130 may receive information reflecting available loan products from financial service provider 110 via, for example, server 111, server(s) 311, or the like.

Based on the results of the search, lender search process 710 may generate an interface identifying qualifying small businesses 150 for selected loan products. In other embodiments, lender search process 710 may be configured to generate an offer that is customized for each qualified small business 150 identified from the search and send the offer to the qualified small business 150. For example, lender search process 710 may generate an email that is provided from lending system 130 to a qualified small business 150 using known email communication computing devices and mechanisms. Alternatively or in addition, lending search process 710 may generate and send an offer to a qualified small business 150 through the lending service portal that is accessed by the qualified small business 150 over the Internet. For example, a user of small business 150A (e.g., user 152A) may login and access the lending service portal and see, on an interface, a notification that small business 150A has qualified and is preapproved for a particular loan product. Aspects of the disclosed embodiments may allow small business user 152A to select a link on the interface that directs the user to other interfaces that process acceptance and activation of the qualified loan product. Other processes in memory 423 may be implemented to facilitate providing loan product offers, activating loan products, and processing loan products in accordance with the disclosed embodiments.

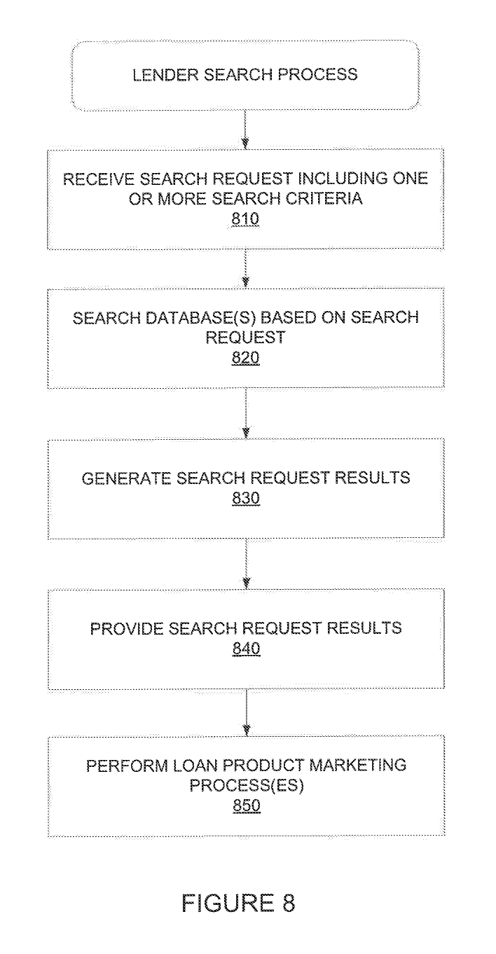

FIG. 8 shows an exemplary lender search process that may be performed by lending system 130 consistent with certain disclosed embodiments. In step 810, lending system 130 may receive a search request including one or more search criteria. Based on the search criteria, lending system 130 may search database(s) 430 for business data associated with one or more small businesses 150 who have provided business data (e.g., registered small businesses) (step 820). Lending system 130 may generate search request results including the identity of one or more small businesses 150 that meet the search criteria (step 830). The search request results may be further processed to determine whether identified small businesses 150 meet other criteria. Further, or alternatively, lending system 130 may process the search request results to match loan products with small businesses 150. Lending system 130 may provide the search request results to a memory or other processes of lending system 130 for subsequent processing (step 840). In one embodiment, lending system 130 may perform loan product marketing processes to market one or more loan products to qualified small businesses 150 (step 850) (e.g., emails, text, web page notifications, automated telephone messages, etc.).

Credit rating process 712 may be a process that performs a credit check for small business 150. For example, lending system 130 may execute credit rating process in response to a selection by a user associated with small business 150 (e.g., user 152A) on an interface provided through the lending service portal. For example, small business 150A may be registered with lending system 130 and provide lending system 130 with business data from data sources (e.g., 154A-158A). Lending system 130 may store the business data for small business 150A in database(s) 430. Credit rating process 712 may use the stored business data associated with small business 150A to determine a credit score or health value. For example, credit rating process 712 may evaluate business data, such as consumer reviews, profit information, sales transaction, or any other historical data over a range of time (e.g., month, quarter, year(s), etc.). Based on the evaluation, credit rating process 712 may determine a credit rating for small business 150A and generate a notification to provide the rating to small business 150A or the user requesting the credit report (e.g., user 152A). Thus, in certain aspects, small businesses 150 may use aspects of lending system 130 (e.g., data mart 427 and database(s) 430) to obtain information about the health of their business from the perspective of lending system 130 and/or financial service provider 110. The credit rating notification may include information or links to information (via hyperlinks, etc.) that provide recommendations of available and qualified loan products (such as those determined by lender search process 710) or recommendations of how small business 150A may increase its credit rating to become eligible for loan products (e.g., such as those determined by recommendation processes 718, 720 described below).

Data source collection process 714 may be a process that allows small businesses 150 to provide business data to lending system 130 consistent with disclosed embodiments. In one embodiment, lending system 130 may be configured to provide lending services to small businesses 150 that register with lending system 130. Once registered, small businesses 150 may provide lending system 130 with business data that may be stored, configured, processed, and evaluated by lending system 130 (and/or financial service provider 110) for various purposes. One purpose may be to provide loan products to a registered and qualified small business 150. Another purpose may be to allow a registered small business 150 to manage loan products that have already been activated and provided to small business 150. Another purpose may be to allow lending system 130 to perform assessments of a registered small business 150 to identify loan products of which small business 150 may not have been aware or previously eligible to receive. Other purposes may be provided by the disclosed embodiments, and the above descriptions are non limiting examples.

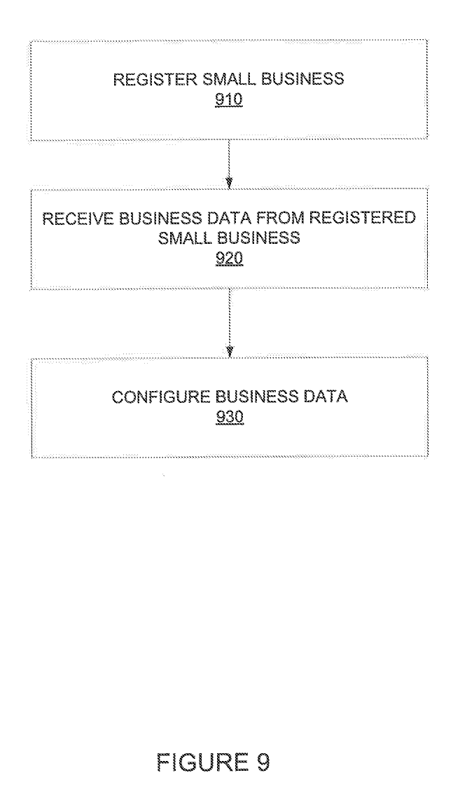

FIG. 9 shows a flow chart of an exemplary registration process that lending system 130 may perform consistent with certain disclosed embodiments. At step 910, a small business (e.g., small business 150A) may register with lending system 130. In one embodiment, small business 150A may register with lending system 130 through the lending service portal. For instance, a user (e.g., user 152A) may access the lending service portal provided by lending system 130 to register small business 150A. Registration may involve providing certain initial business data to lending system 130, configuring communication links and protocols with lending system 130 to facilitate the exchange of business data, downloading and executing software provided by lending system 130 to facilitate the exchange of data, and other configuration processes. During registration, small business 150A may also provide information that identifies the data sources of certain types of business data. For example, small business 150A may provide lending system 130 with the identities and/or locations of data sources 152A-158A for certain types of business data. This way, lending system 130 may be able to determine the source of certain business data if lending system 130 requires additional business data. For instance, lending system 130 may be notified that sales transaction business data may be found from data source 158A and supplier related data from data source 152A. At step 920, lending system 130 may receive business data from small business 150A. Registered small business 150A may provide the business data over network 140 or other communication links. Once received, lending system 130 may configure the business data for registered small business 150A (step 930). For example, lending system 130 may generate and store one or more records in database(s) 430 associated with registered small business 150A. For example, lending system 130 may create data records, data structures, and the like that are specific to registered small business 150A such that business data can be searched.

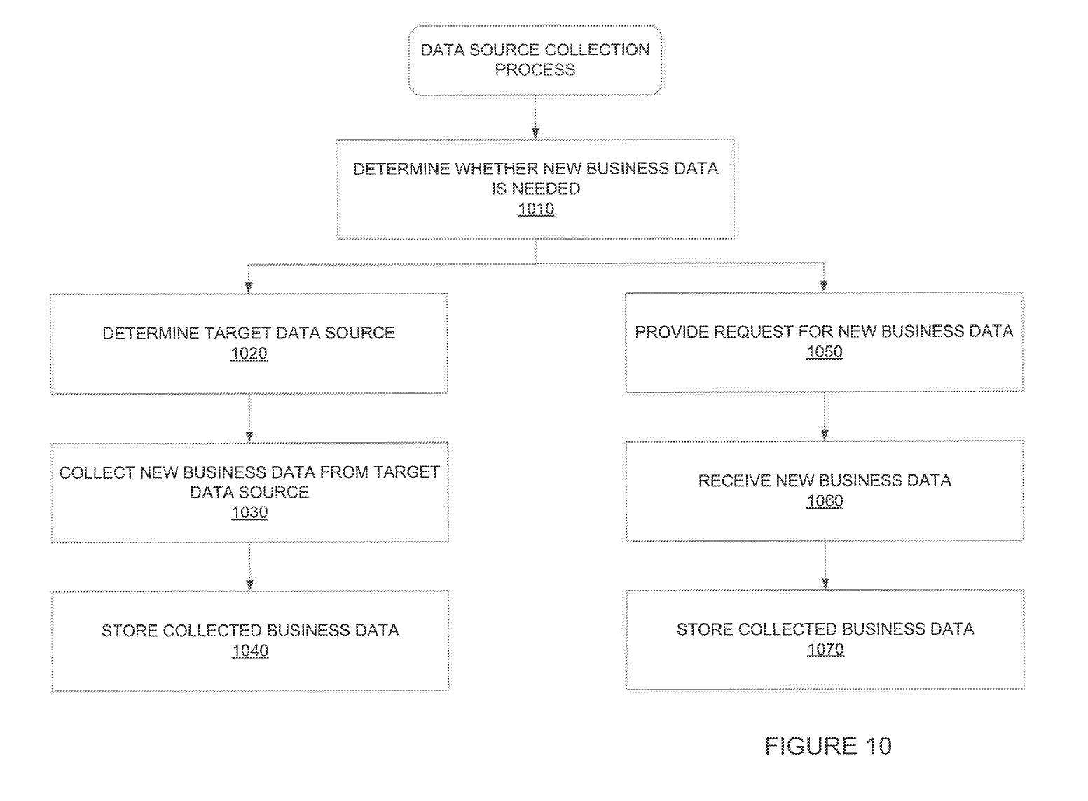

FIG. 10 shows a flowchart of an exemplary data collection process that may be performed by the disclosed embodiments. In one embodiment, lending system 130 may process business data for certain registered small businesses 150. The business data may be stored by lending system 130 during initial registration of small business 150 or may be received and stored when small business 150 requests approval for a loan, requests a credit check, etc. The business data may be stored in database(s) 430 or stored in another memory of lending system 130. Thus, in one aspect, lending system 130 may determine whether new business data is needed for the small business (e.g., small business 150A) being evaluated (step 1010). If new business data is needed (e.g., lending system 130 determines that new business data is needed to provide a better loan assessment for the small business 150A), lending system may, in one embodiment, execute software that determines a target data source of the new business data (step 1020). For example, lending system 130 may determine, based on the analysis in step 1010, that lending system needs to review sales transaction data for small business 150A over the past year. Lending system 130 may determine that this type of business data is provided by small business 150A from a particular data source (e.g., data source 158A). For instance, data source 158A may be a sales transaction database that small business 150A uses to store sales transaction data. Once the target data source is determined, lending system 130 may collect the new business data from the target data source (step 1030). Lending system 130 may then store the collected new business data in the appropriate formats, configurations, etc. in the appropriate locations in memory such that it is usable by lending system 130 to perform certain loan processes consistent with the disclosed embodiments.

In other embodiments, if lending system 130 determines that new business data is needed (step 1010), lending system 130 may generate and provide a request for the new business data to small business 150A (step 1050). For example, lending system 130 may generate a request that is provided in an email to a user (e.g., user 152A) of small business 150A. Lending system 130 may also be configured to provide the request to small business 150A via the lending service portal, such as a message that is shown in an interface to a user (e.g., user 152A) when they log onto the lending service. In response to the request, small business 150A (via user 152A, client device 160A, server 151, 521, and/or other devices) may provide the requested new business data to lending system 130. Lending system 130 may receive the new business data (step 1060) and then store the collected business data (step 1070). Lending system 130 may store the collected business data during step 1070 in a manner consistent with that disclosed above in connection with step 1040.

Referring back to FIG. 7, loan generation process 716 may be a process that generates loan products for small business 150 consistent with disclosed embodiments. In one aspect, lending system 130 may provide an option for small business 150 to have its financial health monitored automatically by lending system 130. In certain embodiments, lending system 130 may allow a registered small business (e.g., small business 150A) or a user associated with the business (e.g., user 152A) to configure monitoring parameters that may be tracked by lending system 130 to identify loan event(s). A loan event may be an event that relates to an unhealthy financial condition for the small business 150A, such as, for example, a low capital account balance, a low payroll account balance, certain expected income or payments were not received by a certain date, etc. Loan events may trigger processes in lending system 130 that may allow lending system 130 to activate preapproved loan products (or initiate an approval of a loan product) such that lending system 130 may provide a small business 150 with access to funds in a timely manner (e.g., near immediate, within minutes, hours, etc.). Lending system 130 may provide mechanisms that enable small business 130 to configure loan events, parameters that are tracked, rules and conditions associated with loan events, etc. For example, lending system 130 may provide interface(s) that a user (e.g., user 152A) may use to set rule(s), threshold(s), configure loan events, etc. for registered small business 150A.

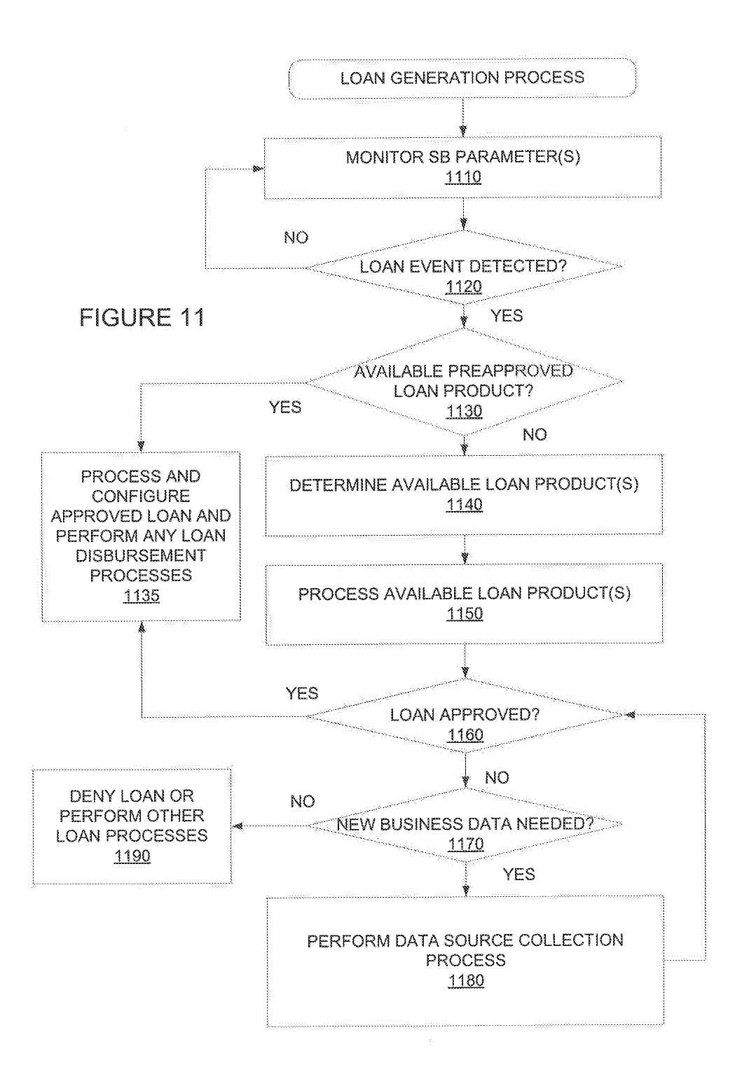

FIG. 11 shows a flowchart of an exemplary loan generation process consistent with certain disclosed embodiments. In one embodiment, lending system 130 may execute software instructions that monitor one or more small business parameters associated with small business 150 (step 1110). For example, lending system 130 may check whether a designated account has a balance below a determined threshold value. Lending system may also check whether the designated account has a balance below a determined threshold value when accounting for near term (e.g., within days, weeks, or months) expected withdrawals (i.e., reoccurring office expenses such as payroll, rent, utilities, etc.) Based on the monitored parameter(s), lending system 130 may determine whether a loan event is detected (step 1120). If not (step 1120; No), the process continues with monitoring small business parameters (step 1110). But if a loan event is detected (step 1120; Yes), lending system 130 may determine whether small business 150A is associated with any available preapproved loan products (step 1130). If so (step 1130; Yes), lending system 130 may process and configure the approved loan and perform any loan disbursement processes (step 1135). For example, lending system 130 may be configured to automatically activate a preapproved loan product for small business 150A based on the determined loan event. For instance, if a payroll account is depleted below a threshold, lending system 130 may determine that small business 130 has been preapproved for a line of credit for a certain amount (e.g., $50,000). Thus, lending system 130 may automatically activate the line of credit and automatically transfer the line of credit funds to a determined account for small business 150A (e.g., the payroll account). Lending system 130 may alternatively notify financial service provider 110 to activate a loan product and handle the disbursement of funds.

If, however, lending system 130 determines that there are no available preapproved loan products (step 1130; No), lending system 130 may determine one or more available loan products that financial service provider 110 or a lender may offer small business 150A (step 1140). Lending system 130 may also process an identified loan product to determine whether small business 150A is approved for the loan product (step 1150). Lending system 130 may automatically perform loan approval processes by, for example, checking business data for small business 150A that may be stored in lending system 130. Lending system 130 may determine that small business 150A is approved for an identified loan product (step 1160; Yes) and then, in one embodiment, process and configure the approved loan and perform any loan disbursement processes (step 1135). If, however, lending system 130 does not approve the small business 150A for an available loan product (step 1160; No), lending system 130 may determine whether new business data is needed (step 1170). If new business data is needed (step 1170; Yes), lending system 130 may perform a data source collection process to collect new business data that may be used by lending system 130 to reevaluate the loan approval (step 1180). The data source collection process may be the data source collection process described above in connection with FIG. 10. Lending system 130 may then determine whether the loan was approved based on the new business data collected from small business 150A. If lending system 130 determines that no new business data is needed (step 1170; No), such as where lending system 130 has all of the relevant information it needs to assess a loan product, lending system 130 may determine to deny the loan or perform other loan processes (step 1190), such as notifying small business 150A of a need to discuss other options. Lending system 130 may, in one example, inform financial service provider 110 (via server 111, server(s) 311, etc.) that a loan was denied to allow financial service provider 110 to perform processes for notifying small business 150A.

Referring back to FIG. 7, business driver recommendation process 718 may be a process that determines one or more business drivers that a small business 150 may need to improve in order to qualify for one or more loan products. For example, lending system 130 may execute business driver recommendation process 718 when small business 150A is not approved for a loan product or when performing a credit rating process 712. Lending system 130 may analyze business data provided by the small business 150A to determine adjustments that small business 150A may do to its business to increase its chances of being approved for a loan product. For instance, business driver recommendation process 718 may determine, based on the stored business data, that small business 150A may increase its credit rating by paying down certain debt over a certain period of time. Other business driver recommendations can be provided by the disclosed embodiments, and the examples listed above are exemplary.

Data source recommendation process 720 may be a process that may determine one or more data sources to which small business 150A may provide lending system 130 access in order to increase the ability for small business 150A to qualify for loan products. For example, data source recommendation process 720 may determine that lending system 130 needs to evaluate customer reviews to assess how well small business 150A is performing in its sale of certain products. In this example, data source recommendation process 720 may generate and provide a notification to small business 150A (via, for example, server 151A, 511) that informs small business 150A (or user 152A) to provide business data associated with such information. Small business 150A may configure its registered lending service with lending system 130 so as to provide lending system 130 access to a data source that stores customer review information.

Loan application process 722 may be a process that processes loan product requests from small business 150 to determine whether to approve the loan product. FIG. 12 shows a flowchart of an exemplary loan application process that may be performed by the disclosed embodiments. At step 1210, lending system 130 may receive a request for a new loan product from small business 150 (e.g., small business 150A). Lending system 130 may then process the loan request using stored business data associated with small business 150A (step 1220). Lending system 130 may determine whether the loan is approved (step 1230). If so (step 1230; Yes), lending system 130 may process and configure the loan in accordance with the loan request (step 1260). If, however, lending system 130 determines that the loan is not approved (step 1230; No), lending system 130 may determine whether new business data is needed to further evaluate the loan request (step 1240). If not (step 1240; No), lending system 130 may deny the loan and perform any other loan processes for handling the loan denial (step 1270). If lending system 130 determines that new business data is needed (step 1240; Yes), lending system 130 may perform a data source collection process, a data source recommendation process, and/or a business driver recommendation process consistent with that disclosed above (step 1250). Lending system 130 may then reevaluate the loan request to determine whether the loan is approved (step 1230).

Loan management process 724 may be a process that provides mechanisms for small business 150 to manage loan products or potential loan products consistent with certain disclosed embodiments. For example, lending system 130 may provide, e.g., through the lending service portal, options for a user (e.g., user 152A) to, for example, access loan account information or perform certain tasks (e.g., credit rating checks, provide loan payments, etc.). Lending system 130 may provide interfaces through the lending service portal to allow a user to select, control, view, access, and request information associated with small business 150. FIG. 13 shows a loan management process that may be performed by the disclosed embodiments. In step 1310, lending system 130 may receive a request to access a loan account. In one example, a user (e.g., user 152A) associated with small business 150A may provide the request to lending system 130 via the lending service portal. For instance, user 152A may log on and provide authentication information to lending system 130 through interface(s) provided via the lending service portal. Lending system 130 may authenticate the request (step 1320). Once the request is authenticated, lending system 130 may generate and provide one or more interface(s) that provide one or more loan management options for user 152A to select (step 1330). Lending system 130 may receive a selection of a loan management option (step 1340). For example, lending system 130 may provide, via the lending service portal, an interface that provides options for user 152A to select. For example, lending system 130 may provide an interface to access current loan product account information for small business 150A, provide payments for current loan products, review available loan products for which small business 150A may qualify, etc. Based on a selection, lending system 130 may perform a loan management sub-process (step 1350). For instance, lending system 130 may generate and provide interface(s) that provide loan account information for small business 150A based on user 152A's selection on an interface.

FIG. 14 shows an exemplary interface that may be provided by the disclosed embodiments consistent with exemplary loan management processes. For example, lending system 130 may provide lender service interface 1400 in response to a user (e.g., user 152A) logging onto the lending service portal provided by lending system 130. The format, configuration, options, look and feel, etc. of lender service interface 1400 is exemplary. The disclosed embodiments may provide any type of interface with different options, text, graphics, recommendations, links, formats, etc. consistent with the operations associated with the disclosed embodiments. In this example, interface 1400 may include an option for a user to upload business data relating to small business 150 (e.g., option 1410). In one embodiment, when option 1410 is selected, lending system 130 may perform a data source collection process consistent with that disclosed above.

Interface 1400 may also provide an option that allows a user to link the system(s) of small business 150 to lending system 130 (e.g., option 1420). For example, when option 1420 is selected, lending system 130 may provide an interface that informs a user how to link system(s) of small business 150 with lending system 130, such as linking the money management software of small business 150 (e.g., financial software offered by Quicken) so that lending system 130 can automatically receive business data from the software. Interface 1400 may also provide an option that allows a user to check the credit for small business 150 (e.g., option 1430). In one embodiment, lending system 130 may perform credit rating process 712 disclosed above. Interface 1400 may also provide an option for a user to manage loans for small business 150 (e.g., option 1440). In one embodiment, lending system 130 may perform loan management process 1350 disclosed above in connection with FIG. 13.

Interface 1400 may also include an option for a user to view available loan products for small business 150 (e.g., option 1450). When selected, lending system 130 may provide an interface that shows one or more loan products that small business 150A has with financial service provider 110 or a lender, and/or one or more loan products that small business 150A may be eligible to receive based on loan approval assessments performed by lending system 130 using stored business data provided by small business 150A. FIG. 15 shows an exemplary available loan products interface consistent with certain disclosed embodiments. As shown, lender service interface 1500 may include an available loan products interface 1520 that lists available loan products that lending system 130 has determined that small business 150A is eligible to receive. Interface 1520 may include an identification of the loan accounts 1510 and 1520, and parameters (e.g., 1512, 1516, 1522, and 1526) associated with each loan product. Loan parameters may include, for example, interest or financing rates, available balance of credit limits, penalty fees, etc.

Interface 1400 may also include a message board 1460 that allows a user to communicate with a representative of lending system 130 and/or financial service provider 110 (e.g., online blogs, text messages, etc.) In another embodiment, interface 1400 may provide reward points option 1470 that, when selected, provides a listing of reward points for the small business based on certain conditions. For example, lending system 130 may execute software that creates, maintains, and manages a reward point plan for small businesses 150 based on loan payments, number of loan products, credit rating, etc. Reward points may include incentives or discounts associated with loan products, such as for example, reduced interest rates for a specified period of time, reductions in balances, late fee forgiveness, etc.

In another embodiment, interface 1400 may include activate standby loan option 1480. When selected, lending system 130 may provide interface(s) to a user that allows the user to activate one or more standby loan products that small business 150A may use, such as when a loan event is detected or experienced.

FIG. 16 shows an exemplary interface that may be provided by lending system 130 consistent with certain embodiments. In this example, lending system 130 may provide interface 1600 to show a user (e.g., user 152A) active loan products (e.g., interface 1650) and standby loan products (e.g., interface 1660) associated with small business 150A. Active loan products interface 1650 may list one or more loan products that small business 150A has with financial service provider 110 (or another lender), such as loan accounts 1610 and 1620, along with each loan account's parameters (e.g., parameters 1612, 1616, 1622, and 1626). Standby loan products interface 1660 may identify one or more standby loan products that lending system 130 has configured and approved for small business 150. For example, standby loan products interface 1660 may list an available standby loan product 1630 for small business 150A and the parameter(s) associated with the standby loan product (e.g., parameters 1632, 1636). In one embodiment, standby loan product interface 1660 may include an option for a user (e.g., user 152A) to activate the standby loan product (e.g., “Activate Now” option) that, when selected, directs lending system 130 to activate and configure the standby loan for small business 150. For instance, user 152A may access the lending service portal provided by lending system 130 to request standby loan products interface 1660 and to select the option to activate standby loan product 1630 based on a loan event that small business 150A may be experiencing.

In certain embodiments, lending system 130 may provide mechanisms that allow a user (e.g., user 152A) to configure one or more rules associated with standby loan products provided through the lending service portal of lending system 130. For example, FIG. 17 shows an exemplary interface that includes options for a user to configure standby loan products for small business 150A. For instance, interface 1700 may include configure standby loan products interface 1750 that identifies a standby loan account (e.g., Loan Account SL1 1730) for small business 150A and options for configuring how to trigger activation of the standby loan (e.g., configure standby loan rules (SLR) options). In one embodiment, lending system 130 may execute processes that allows a user (e.g., user 152A) to set one or more standby loan rules (e.g., rules SL1R1, SL1R2, Sl1Rx) that control how lending system 130 handles loan events and standby loan products consistent with disclosed embodiments. For example, user 152A may use interface 1760 to configure a rule that directs lending system 130 to activate standby loan account 1730 when an identified payroll account balance falls below a certain number within a certain time period or within a range of time before a certain date (e.g., if payroll account falls below $10,000 by the 13^{th} of every month, then automatically activate standby loan product 1730). Lending system 130 may provide menu options, text input cells, or other forms of data input options to allow a user (e.g., user 152A) to configure one or more standby loan rules in accordance with disclosed embodiments.

As described above, the disclosed embodiments provide processes and systems that dynamically provide loan products and loan management processes to small businesses 150. The disclosed embodiments include memory that stores business data and loan data that is accessible and usable by components of the disclosed systems to perform one or more operations consistent with the disclosed embodiments. FIG. 18 shows exemplary memory 1800 storing exemplary data structures that may include data usable by components of the disclosed embodiments to perform such operations. In one example, memory 1800 may be a memory included in lending system 130. Memory 1800 may also be a memory included in financial service provider 110 or small businesses 150. As shown, memory 1800 may include a small business data structure SB1 that includes loan information (e.g., loan accounts 1810, 1820) and associated parameters (e.g., parameters 1812, 1816, 1822, 1826) associated with a small business (e.g., small business 150A). Memory 1800 may also store standby loan products data structure 1860 that includes loan information (e.g., loan account 1830) and associated parameters (e.g., parameters 1832, 1836) relating to a standby loan for small business 150A. Data structure 1860 may also include a data structure storing one or more rules (e.g., rules 1838) associated with standby loan product 1830. Memory 1800 may also store rules data structure 1870 that stores data and software instructions associated with one or more rules (e.g., rules R1, R2, . . . Rx) that lending system 130 may use to determine how to process loan events.

FIG. 19 shows a block diagram of an exemplary relationship between loan products and rules, consistent with certain disclosed embodiments. For example, the disclosed embodiments may include loan memory 1910 that stores loan information relating to one or more loan products (e.g., active loan accounts 1912, 1914, preapproved standby loan accounts 1916 and 1918). Memory 1910 may be a memory included in lending system 130, financial service provider 110, or other components of the disclosed systems. The disclosed embodiments may also include rule memory 1920 that stores loan rules 1922, 1924, 1926, 1928, that include data and software instructions associated with rules that lending system 130 may execute when performing one or more operations consistent with the disclosed embodiments. Memory 1920 may be stored in lending system 130, financial service provider 110, or other components of the disclosed systems. In one example, certain rules may apply to certain loan products. For instance, as shown, loan rule R1 1922 may be related to standby loan account SL1 1916 based on its configuration shown to the right of loan rule 1922. Similarly, loan rules R2 1924 may be related to standby loan account SL1 1916 based on its configuration (shown to the right of loan rule R2 1924). Standby loan account SL1 1916 may also be related to loan rule R4 1928. Also, as shown, loan rule R3 1926 may be related to standby loan account SL2 1918 based on the rule configuration shown to the right of loan rule R3 1926.

The disclosed embodiments are not limited to configuration, relationships, formats, and types of rules and loan products shown in FIGS. 18 and 19. Instead, lending system 130 may be configured to use any type of rule to control how to handle certain loan events in accordance with the disclosed embodiments. For instance, lending system 130 may implement rules that are associated with other loan rules (e.g., perform a first rule, which cause a second rule to be performed). Further, lending system 130 may implement rules that monitor for loan events, such that if a loan event occurs that warrants activating a loan and lending system 130 determines that existing standby loan products for small business 150 will not cover the funds needed to address the loan event, lending system 130 may execute a rule that automatically initiates a loan request and loan approval process for a different loan product for that small business. As another example, the disclosed embodiments may implement emergency options that allow lending system 130 to automatically provide funds to a designated account for a small business 150. The designated accounts may include personal bank accounts of individuals (e.g., employee bank accounts), corporate accounts, etc.

Other embodiments will be apparent to those of ordinary skill in the art from consideration of the specification and practice of the disclosed embodiments. It is intended that the specification and examples be considered as exemplary only, with a true scope and spirit of the disclosed embodiments being indicated by the following claims. For example, while the disclosed embodiments are disclosed in connection with small business (e.g., businesses with annual revenues less than $1MM), they may be implemented with other types of business, such as medium-sized or large businesses (e.g., businesses with annual revenues more than $1MM). Thus, small businesses 150, as disclosed herein, may reflect other types of businesses or sizes of businesses. Moreover, the disclosed embodiments may be implemented with any type of financial service product and are not limited to financial loan products. Moreover, one or more processes associated with the disclosed embodiments may be performed by one or more processors executing software instructions. Some operations may be performed by a computing system(s) included with a lending system, financial service provider, small business, or a combination of these components. The lending service portal embodiments may be provided by a server that is configured to execute software instructions to provide online portals (e.g., web site, etc.) that are accessible using known Internet or other network related communication mechanisms and protocols. Moreover, the interfaces associated with the disclosed embodiments may be generated and provided by a server that is configured to generate web-based interfaces that include content, hyperlinks, and the like, known to one of ordinary skill in the art. The interfaces associated with the disclosed embodiments may be displayed via a display device included in a computing system associated with one or more of the lending system, financial service provider, and/or small business components. The components that receive and display the interfaces associated with the disclosed embodiments may be rendered by software instructions executed by one or more processors configured to generate and display such interfaces, as is known to those skilled in the art (e.g., browser software, etc.).

In addition, the disclosed embodiments provide methods and systems that monitor one or more financial health characteristics associated with the small business based on analysis of business data. The financial health characteristics may include, for example, a low cash amount in one or more financial accounts for the small business, a forecast of low future sales, a history of low sales, a receipt of fines or other situations that may reduce the income or profit of the small business, a decrease in workforce staff (e.g., a certain number of employees being laid off or losing their jobs), or any other information that may reflect the financial strength of the small business. The disclosed embodiments may also identify a loan event associated with a small business based on the monitoring of financial health characteristics. A loan event may include an unhealthy financial event associated with the small business, such as, for example, low sales volumes, low profits, reduced inventory, characteristics with a supplier of the small business (e.g., a main supplier shuts down, closes, or stops delivering supplies to small business), etc.

In addition, the disclosed embodiments provide systems and methods that enable a small business to provide business data that may be considered by a financial service provider, lending system, etc. to determine whether the small business is to receive a loan product, such as a small business loan. The business data may include information that is not typically received and assessed by financial service providers or lender in evaluating whether a business is to receive a loan. For example, the business data may include consumer reviews relating to a small business. The business data may also include tax information, payroll information, business growth expectation information, forecast information, payment metrics, etc.

Furthermore, although aspects of the disclosed embodiments are described as being associated with data stored in memory and other tangible computer-readable storage mediums, one of ordinary skill in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

1-20. (canceled)

21. A method for providing an aggregated financial service account, the method comprising:
registering, at a server, a business using an online lending service portal provided by a lending system;
establishing an electronic communication link to the business;
receiving, via the electronic communication link, first business data from the business;
storing the first business data;
analyzing the first business data to determine whether the business qualifies for a first loan product provided by a financial service provider;
determining, based on the analysis, that second business data is needed to determine whether the business qualifies for the first loan product;
identifying a data source of the second business data for determining whether the business qualifies for the first loan product;
providing, via the online lending service portal, a first notification to the business, the first notification providing the identity of the data source and informing the business of the need for the second business data;
receiving, via the electronic communication link, second business data comprising the second business data from the business;
monitoring a financial health characteristic associated with the business based on at least one of the first business data or the second business data;
identifying, based on the monitoring, a loan event associated with the business, the loan event reflecting an unhealthy financial event associated with the business;
activating a second loan product for the business, by which funds associated with the second loan product are disbursed to a financial account associated with the business;
providing a second notification to the business, the second notification stating that the business qualifies for the second loan product;
displaying the second notification on an interface; and
performing loan management processes associated with at least one of the first or second loan products.

22. The method of claim 21, further comprising:
performing a process that allows funds relating to at least one of the first or second loan products to be disbursed to a determined financial account associated with the business, based on the analysis of the second business data.

23. The method of claim 22, further comprising:
providing an interface that includes loan management options, the loan management options comprising a first loan management option;
receiving the selection of a first loan management option; and
performing a first loan management process based on the first loan management option.

24. The method of claim 23, wherein the first loan management process comprises at least one of:
providing, in an interface, account information associated with at least one of the first or second loan products;
performing a credit check for the business based on the first or second business data;
activating at least one of the first or second loan products; or
configuring a rule for controlling how to activate at least one of the first and second loan products.

25. The method of claim 23, wherein the first loan management process comprises providing information associated with a third loan product that the business is eligible to receive, the third loan product being a loan product that the business did not request to receive.

26. The method of claim 25, wherein the first loan management process further comprises at least one of:
providing account information associated with at least one of the first, second, or third loan products displayed on an interface;
performing a credit check for the business based on the first or second business data;
activating at least one of the first, second, or third loan products; or
configuring a rule for controlling how to activate at least one of the first, second, or third loan products.

27. The method of claim 21, further comprising:
analyzing at least one of the first or second business data to determine whether the business is preapproved for the second loan product; and
providing an indication to the business that the business qualifies for the second loan product.

28. The method of claim 21, wherein the activation of the second loan product comprises automatically disbursing funds associated with the second loan product to a financial account associated with the business.

29. The method of claim 21, wherein activating the second loan product comprises:
receiving a request from the business to activate the second loan product; and
activating the second product in response to the request

30. The method of claim 21, further comprising:
receiving input specifying a rule for controlling how the second loan product is to be activated and disbursed.

31. The method of claim 21, wherein the second loan product comprises a loan product that the business is preapproved to receive.

32. The method of claim 21, wherein the second loan product comprises a loan product that the business did not request to receive.

33. The method of claim 21, further comprising:
registering the business by receiving a request by the business to register, the registration request being received via a lending service portal comprising an interface receiving user information associated with the business.

34. The method of claim 21, wherein the one or more processors are further configured to request the second business data from a system of the business.

35. A method for identifying a business eligible for a loan product, the method comprising:
registering, at a server, a plurality of businesses using an online lending service provided by a lending system;
establishing one or more electronic communication links to the businesses;
receiving business data from the businesses via the electronic communication links;
storing the business data;
receiving, from a first interface, search criteria associated with qualifying for the loan product;
identifying at least one of the businesses that qualifies for the loan product based on the search criteria and the stored business data;
generating an offer for the loan product that is customized for the identified business;
transmitting the offer to the identified business via an online lending service portal that provides a second interface for a user associated with the identified business; and
receiving, via the lending service portal, acceptance of the offer.

36. A method for providing an aggregated financial service account, the method comprising:
registering a business at a server using an online lending service provided by a lending system;
establishing an electronic communication link to the business;
receiving business data from the business via the electronic communication link;
storing the received business data;
analyzing the stored business data to determine a characteristic of the business, the characteristic comprising at least one of a credit rating for the business or whether the business qualifies for a loan product provided by a financial service provider;
identifying, based on the analysis, a business driver associated with the business whose adjustment would change the determined characteristic;
generating a recommendation to the business for improving the business driver, based on the identification; and
transmitting the recommendation to the business via an online lending service portal that provides an interface for a user associated with the business.
